(19) United States
(12) Patent Application Publication
(10) Pub. No.: US 2013/0226966 A1
(43) Pub. Date: Aug. 29, 2013

(54) PROCESSING A HIERARCHICAL STRUCTURE TO RESPOND TO A QUERY

(71) Applicant: Technion Research & Development Foundation, (US)

(72) Inventors: Oded SHMUELI, Nofit (IL); Lila Shnaiderman, Haifa (IL)

(73) Assignee: Technion Research & Development Foundation Limited, Haifa (IL)

(21) Appl. No.: 13/778,349

(22) Filed: Feb. 27, 2013

Related U.S. Application Data
(60) Provisional application No. 61/603,494, filed on Feb. 27, 2012.

(51) Int. Cl. G06F 17/30

(52) U.S. Cl. CPC G06F 17/30545
USPC 707/770

(57) ABSTRACT

A method of processing of processing a hierarchical structure to respond to a query, comprising:
a) Providing a hierarchical structure having a plurality of nodes of a plurality of node types.
b) Receiving a query that defines a hierarchical query pattern defining hierarchical relationship between at least two query nodes.
c) Simultaneously exploring the hierarchical structure in a bottom up manner by a plurality of threads to update a mapping data structure for each hierarchical structure node that has the same node type as a corresponding query node. Each thread updates the mapping data structure for each ancestor node of each node according to a match between each ancestor node and a corresponding parent node of the corresponding query node.
d) Simultaneously analyzing the mapping data structure by the plurality of threads to identify at least one portion of the hierarchical structure that matches the hierarchical query pattern.

### RELATED APPLICATION

This application claims the benefit of priority under 35 USC 119(e) of U.S. Provisional Patent Application No. 61/603,494 filed Feb. 27, 2012, the contents of which are incorporated herein by reference in their entirety.

### BACKGROUND

The present invention, in some embodiments thereof, relates to processing a hierarchical structure to respond to a query using multiple processors and, more specifically, but not exclusively, to processing an extensible markup language (XML) query to an XML dataset which may be an XML database and/or document. The methods and systems described herein take advantage of multiprocessing hardware that is nowadays highly accessible and available and harnessing the multiprocessing platforms to processing hierarchical structure to respond to queries.

Hierarchical structures in general and tree structured datasets in particular have become popular as structures for data representation. The hierarchical structure provides a visually coherent and intuitive presentation of the data it holds allowing a human to easily follow a data pattern and interactions between a plurality of data items and/or properties. Data items (also referred to as members) are stored as nodes in the hierarchical structure while relationships between various data items are presented as directional edges connecting the data nodes.

A hierarchical structure is a rooted, possibly ordered structure that includes a plurality of nodes, each node containing one or more data items and/or properties describing the data item and associated with one of a plurality of node groups (node types). The nodes are connected between themselves with a plurality of edges describing the relationships between the plurality of nodes. Each of the nodes includes a node identifier and one or more data items and/or properties and is associated with one of a plurality of node groups. It is possible that a node will not include any information but still be included in the hierarchical structure for structural purposes only. Each of the edges provides relationship information between a parent node and a child node. Each of the edges includes an identifier and is associated with one of a plurality of edge groups (edge types). The edge may include additional information with respect to the relationships between the nodes. A query to the hierarchical structure (usually expressed as a query applied to graph and/or a query against a graph) is a rooted, ordered tree pattern containing nodes and edges (the query may be abstracted as a Twig pattern in professional terms, or as a Twig pattern with additional predicates). The query may include parent-child nodes relationships and ancestor-descendant nodes relationships. Ancestor-descendant relationships refer to relationships between an ancestor node and one or more descendant nodes which are not direct child nodes of the ancestor node, but are rather located further down the tree and are separated by one or more nodes and/or edges from the ancestor node.

The goal of processing a query is to search a hierarchical structure and locate a portion that is isomorphic to the query Twig pattern, and to identify one or more nodes within the hierarchical structure that match corresponding nodes (target nodes) of the query Twig pattern. A match is identified when, for each node of the Twig pattern, a node within the hierarchical structure is found that matches the group type and value of a corresponding node within the query, and the graph nodes identified having structural relational properties with descendant and ancestor nodes that qualify with respect to the corresponding nodes within the query Twig pattern. Identifying a match of the query against the hierarchical structure may include a Boolean match, one or more target nodes match and/or complete tree pattern (Twig) of the query within the hierarchical structure. For Boolean match, the result of processing the query produces a Boolean indication of a match—match or absence of match. For target nodes match, the result and output of processing will be providing the node(s) within the hierarchical structure that match with respect to their corresponding nodes of the query. For complete sub-graph match, the result and output of processing will be providing complete sub-graphs within the hierarchical structure that are isomorphic with respect to the query.

Currently processing a query against a hierarchical structure is mostly performed sequentially or with limited parallelism, leading to inefficient query processing and high latency in providing query results. Sequential processing means processing a single search is performed at a time in which a specific sub-graph of the hierarchical structure is explored to identify the query in it. Some parallel processing is used to process two or more queries to a single hierarchical structure, however to improve efficiency and reduce latency, it is desirable to employ massive parallel processing on a single query.

As technology advances, multiprocessing hardware is becoming available, for example, multi core processors and/or hardware based on single instruction multi data (SIMD) architecture that are capable of simultaneously executing one or more threads. A thread is the smallest sequence of programmed instructions that can be managed independently by an operating system scheduler. SIMD platforms employ processor arrays in which a single instruction or operation may be processed in parallel over data arrays containing multiple data items which are mostly independent of each other. The combination of a multithreading platform coupled with a SIMD architecture allows for massive vector processing enabling parallelization in processing large data arrays containing data items that are mostly independent of each other. An example of SIMD platforms is a graphic processor unit (GPU) which is very wide spread in processing stations, for example desktop computers, laptop computers and/or servers. GPUs are designed to process display data and have evolved to include massive arrays of processors to effectively and quickly process high resolution, high definition display data for fast moving scenes, for example, motion pictures and/or for gaming applications.

Multiprocessing platforms may be used for many other applications other than graphic and video processing. Applications which may have no and/or limited dependency between data items which are involved in the processing may employ a vector processing approach using SIMD platforms in order to reduce processing time and support low latency systems. In order to execute applications using SIMD platforms, it is possible that the algorithms embodied within the applications, may require some modifications in order to execute on SIMD hardware.

### SUMMARY

According to some embodiments of the present invention, there are provided systems and methods for processing a hierarchical structure to respond to a query. A query against a hierarchical structure that includes a plurality of nodes is received, where the query defines a hierarchical pattern and includes zero or more query nodes. Each of the nodes is each associated with a node type out of a plurality of node types. The hierarchical structure is explored in bottom up manner by a plurality of threads executed on a plurality of salve processors. Each of the threads processes a node of the hierarchical structure that has the same node type as one of the nodes of the query. The thread updates a mapping data structure that indicates a match between the relationships of the processed node and its ancestor nodes and the relationships between a corresponding query node and its ancestor nodes. After the mapping data structure is fully updated with respect to the query, the mapping data structure is analyzed to identify one or more portions of the hierarchical structure that complies with the hierarchical query pattern. The plurality of threads may execute simultaneously on the plurality of slave processors.

Optionally, exploring the hierarchical structure by the plurality of threads is done in one or more explore iterations, during each explore iteration another subset of the plurality of nodes is explored to update the mapping data structure with respect to another one of the query nodes.

More optionally, analyzing the mapping data structure by the plurality of threads is done in one or more analysis iterations, during each analysis iteration the mapping data structure is analyzed for a subset of the plurality of nodes with respect to another one of the query nodes.

More optionally, the nodes of the hierarchical structure are enumerated prior to exploring the hierarchical structure in order to provide positioning information for the plurality of nodes which is used by the plurality of threads to navigate through the hierarchical structure.

More optionally, enumeration of the nodes of the hierarchical structure employs depth first search (DFS) order starting at a root node of the hierarchical structure. During enumeration the plurality of nodes is assigned with a tree level indication, an opening index and a closing index to identify the exact hierarchical position of each of said plurality of nodes within said hierarchical structure.

More optionally, the ancestor nodes include parent nodes.

More optionally, results of said analyzing are collected from the plurality of threads and a match indication is outputted.

More optionally, the match indication includes a reference to at least one portion of the hierarchical structure that matches the hierarchical query pattern, where the portion of the hierarchical structure includes at least one node.

More optionally, the hierarchical structure is an extensible markup language (XML) dataset.

According to some embodiments of the present invention, there are provided systems for processing a hierarchical structure to respond to a query using a plurality of threads executed on a plurality of slave processors by creating a mapping data structure. The mapping data structure represents the relations of nodes in the hierarchical structure with ancestor nodes that match the relationships of a corresponding node in the query with parent nodes. Processing is controlled by a control processor that retrieves from a storage medium a hierarchical structure which has a plurality of nodes. The control processor receives a query and initiates and coordinates the processing which is performed by a plurality of slave processing units executing a plurality of threads. The control processor instructs the plurality of threads to explore simultaneously the hierarchical structure and to update a mapping data structure to indicate which of the plurality of nodes has a node type and a set of ancestor nodes that are common with a respective node of the query. The mapping data structure is then analyzed by the plurality of threads to identify at least one portion of the hierarchical structure that matches the query. Each of said plurality of threads is exploring and analyzing one of said plurality of nodes at a time.

Optionally, the plurality of slave processors is embedded within one or more single instruction multiple data (SIMD) hardware unit.

More optionally, the SIMD hardware unit is a graphic processing unit (GPU).

More optionally, the plurality of slave processors and the control processor are integrated within the same hardware platform which is sufficient for processing the hierarchical structure.

More optionally, the plurality of slave processors includes one or more general purpose processors having one or more processing core.

More optionally, the plurality of slave processors includes one or more remote clusters that include one or more slave processors. The remote clusters communicate with the control processor to synchronize processing of the hierarchical structure.

According to some embodiments of the present invention, there are provided methods for creating additional structural hierarchical information for the hierarchical structure to allow simple and efficient navigation of the plurality of threads through the hierarchical structure when processing it. Creation of the additional structural hierarchical information includes construction of a plurality of node type arrays. Each node type array includes a plurality of node entries that are each associated with one of a plurality of nodes within the hierarchical structure having a common node type. In addition link information is created for each node of the hierarchical structure that describes the links between the node and its ancestor nodes all the way a root node of the hierarchical structure. Ancestor nodes may include parent nodes.

Optionally, a single node type array is assigned to a plurality of leaf nodes in order to reduce memory consumption. Within the single node type array, the plurality of leaf nodes is sorted in ascending order according to their node type.

More optionally, the hierarchical structure is an extensible markup language (XML) dataset.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of an exemplary hierarchical structure, according to some embodiments of the present invention;

FIG. 1B is a schematic illustration of an exemplary query to a hierarchical structure, according to some embodiments of the present invention;

FIG. 2 is a schematic illustration of an exemplary system for processing a query to a graph database, according to some embodiments of the present invention;

FIG. 3 is a schematic illustration of an exemplary system for processing a query to a graph database and optional execution modules that process the query, according to some embodiments of the present invention;

FIG. 4 is a schematic illustration of an exemplary process for processing a query to a graph database, according to some embodiments of the present invention;

FIG. 5 is a schematic illustration of an exemplary mapping data structure corresponding to an exemplary query, according to some embodiments of the present invention;

FIG. 6 is a schematic illustration of an exemplary hierarchical structure with updated mapping data structures, according to some embodiments of the present invention; and

FIG. 7 is a schematic illustration of exemplary hierarchical data structures for an exemplary hierarchical structure, according to some embodiments of the present invention.

### DETAILED DESCRIPTION

The present invention, in some embodiments thereof, relates to processing a hierarchical structure in order to respond to a query and, more specifically, but not exclusively, to processing hierarchical structure in order to respond to a query using multiple processors.

According to some embodiments of the present invention, there are provided systems and methods for processing hierarchical structure in order to respond to a query. The system for processing the hierarchical structure includes a control processing unit (physical or logical) that receives the hierarchical structure and the query against the hierarchical structure. Before processing the query, the hierarchical structure is mapped and enumerated to create additional hierarchical structural information for the plurality of nodes of the hierarchical structure that is used to support processing the query to the hierarchical structure. The created information may include a plurality of groups of nodes having identical labels and mapping information of the relationships of each node with ancestor nodes. Enumeration may include assigning tree level information, opening index and closing index to identify the exact hierarchical position of each node within the hierarchical structure. Processing the query is performed in two phases. During the first phase the hierarchical structure is explored in bottom up manner to create mapping data structures for each relevant node within the hierarchical structure. Only nodes which match a respective node within the query (having the same group type and value) are processed. The mapping data structure identifies for its associated node, the descendant nodes that are present in the hierarchical structure and match their corresponding nodes of the query with respect to ancestor-descendant relationships. During the second phase, the plurality of mapping data structures is analyzed to identify matching nodes to query target nodes, which satisfy being a part of a complete match. During the two phases, exploration of the dataset to create the mapping data structures and analysis of the mapping data structures to identify a match is performed simultaneously by a plurality of threads executed on a plurality of slave processing units. The slave processing units may be facilitated through, for example, single-core and/or multi-core central processing units (CPUs), GPUs and/or other SIMD hardware units.

Optionally, the query is an XML query and the hierarchical structure is an XML database.

More optionally, the hierarchical structure is an XML document.

Aspects of the present invention are described below with reference to flowchart illustrations and/or block diagrams of methods, apparatus (systems) and computer program products according to embodiments of the invention.

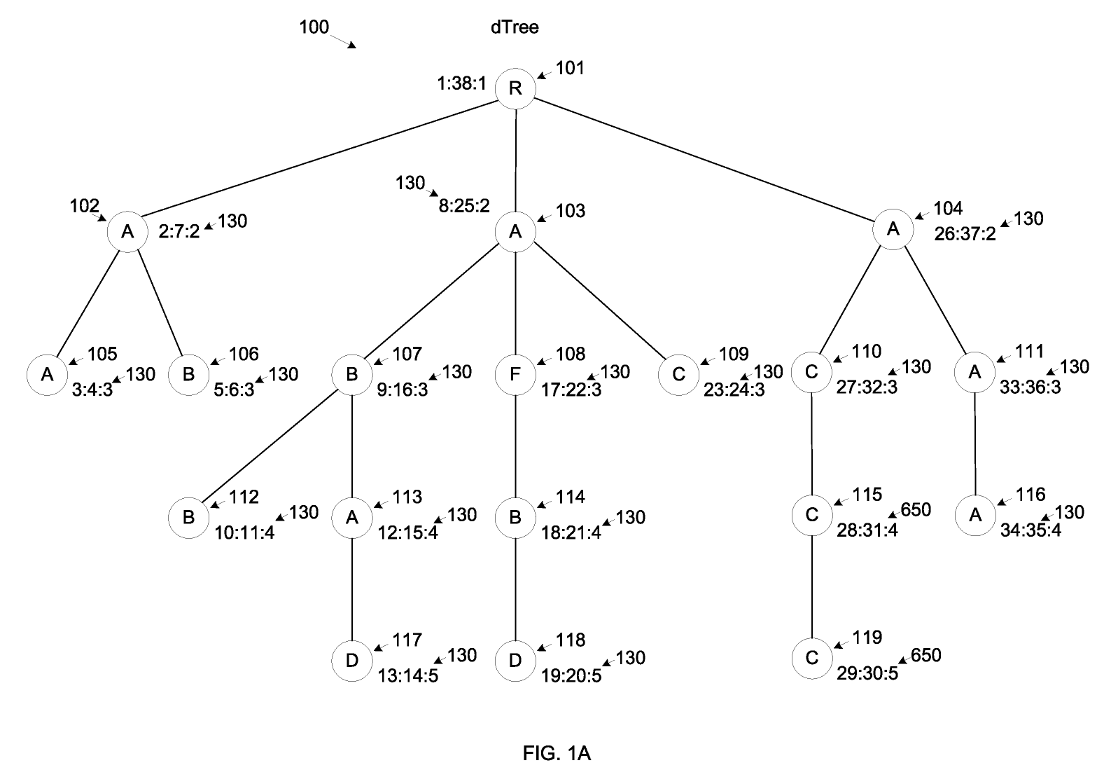

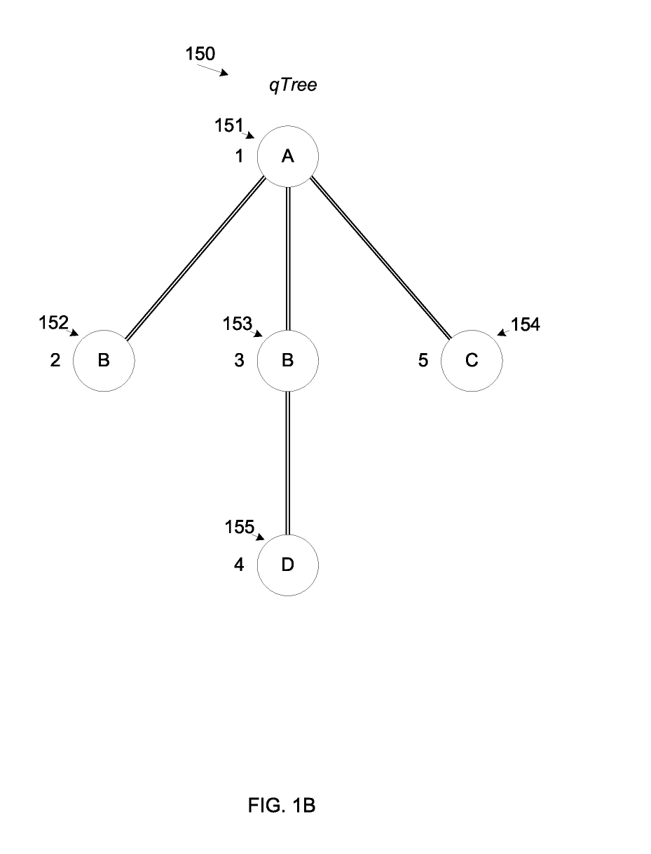

Reference is now made to FIG. 1A which is a schematic illustration of an exemplary hierarchical structure, according to some embodiments of the present invention. A hierarchical structure dTree 100 consists of a plurality of nodes 101 through 119 where all nodes are of the same node group. The nodes 102, 103, 104, 105, 111, 113 and 116 hold data value (label) A, the nodes 106, 107, 112 and 114 hold data value (label) B, the nodes 109, 110, 115 and 119 hold data value C, the nodes 117 and 118 hold data value D and node 108 hold data value F.

Reference is now made to FIG. 1B which is a schematic illustration of an exemplary query to a hierarchical structure, according to some embodiments of the present invention. A query qTree 150 to the hierarchical structure dTree 100 consists of a plurality of nodes 151 through 155 where all nodes are of the same node group. The node 151 holds data value A, the nodes 152 and 153 hold data value B, the node 154 holds data value C and the node 155 holds data value D.

The objective of processing the query qTree 150 against the hierarchical structure dTree 100 is to identify one or more data nodes within the hierarchical structure dTree 100 that match one or more target nodes of the query qTree 150 (target nodes are query nodes which specify the desired answer to the query qTree 150). A match is defined by identifying images of all nodes of the query qTree 150 within the hierarchical structure dTree 100. An image node is a node within the hierarchical structure dTree 100 that has the same value as the query node and maintains the same relationships with ancestor, descendant and sibling nodes of the hierarchical structure dTree 100 as the corresponding nodes of the query qTree 150. The zero or more target nodes are simply some of the nodes of the query qTree 150 marked as such. Prior to processing the query qTree 150, the nodes of the hierarchical structure dTree 100 may be enumerated to assign each node within the hierarchical structure dTree 100 with a specific hierarchical structural position within the hierarchy of the hierarchical structure dTree 100. Enumeration is required to allow efficient positioning and navigation through the hierarchical structure dTree 100 during processing of the query qTree 150.

Optionally enumeration is done in depth first (DFS) order starting from the root node 101 of the hierarchical structure dTree 100.

Reference is now made once again to FIG. 1A which is a schematic illustration of an exemplary hierarchical structure, according to some embodiments of the present invention. An enumeration tag 130 is assigned to each of the plurality of nodes within the hierarchical structure dTree 100. The enumeration tag 130 includes a left position field identifying the opening index of the node, a right position field identifying the closing index of the node and a level ID identifying the nesting level of the node. As shown, enumeration starts from the root node 101 which is assigned an opening index of 1 and level nesting of 1. Moving in DFS order, the node 102 is assigned an opening index of 2 and a level nesting of 2. Moving next in DFS order, the node 105 is assigned an opening index of 3, a closing index of 4 as it has no child nodes and a level nesting of 3 to create an enumeration tag 130 of (3:4:3). Moving next in DFS order, the node 106 is assigned an opening index of 5, a closing index of 6 as it has no child nodes and a level nesting of 3 to create an enumeration tag 130 of (5:6:3). As there are no more child nodes to node 102, the node 102 is assigned with a closing index of 7 to create an enumeration tag 130 of (2:7:2). The enumeration process then moves to node 103 and so on until the entire hierarchical structure dTree 100 is enumerated.

More optionally, additional hierarchical structural information is added to the hierarchical structure dTree 100. The additional information includes construction of a plurality of node type arrays, each node type array holds all nodes of the same node type. In addition node link information is created for each node of the hierarchical structure dTree 100 with respect to its ancestor nodes all the way to the root node 101 of the hierarchical structure dTree 100.

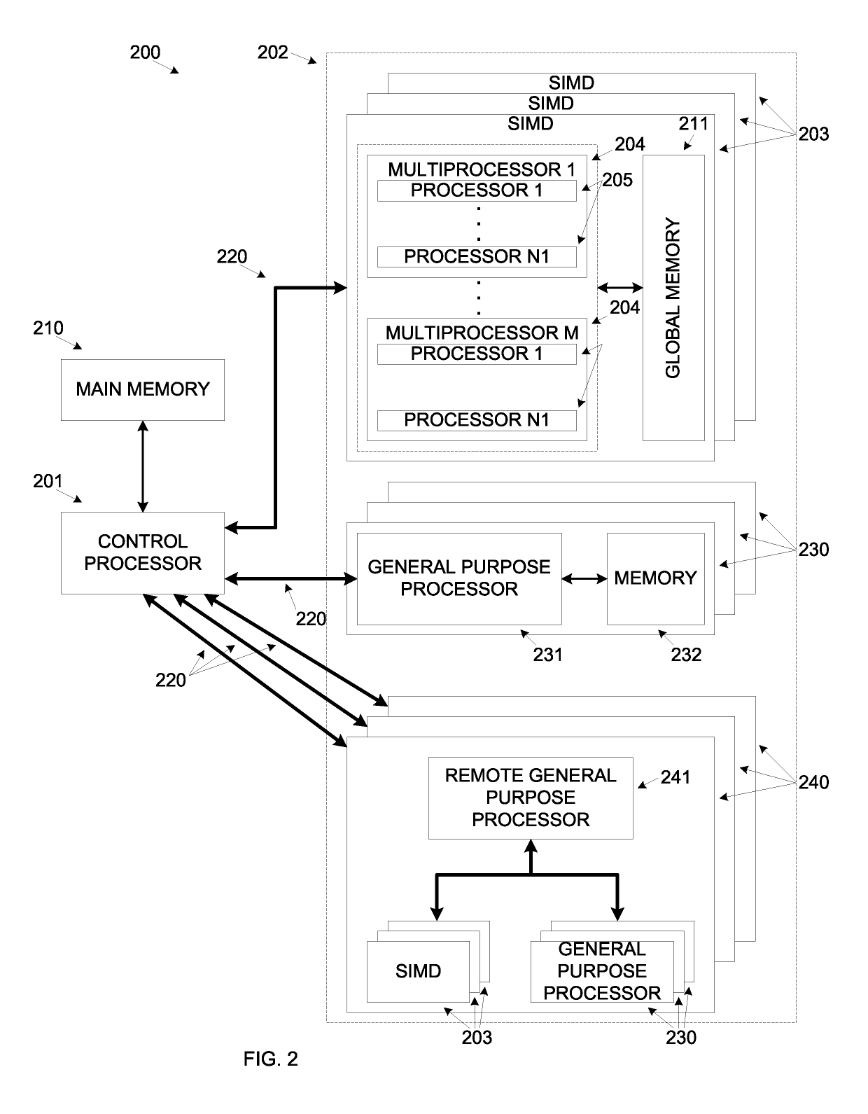

Reference is now made to FIG. 2 which is a schematic illustration of an exemplary system for processing a query to a graph database, according to some embodiments of the present invention. The system 200 includes a control processor 201 (logical and/or physical) that controls processing a query, such as the query qTree 150 to a hierarchical structure such as the hierarchical structure dTree 100. The control processor 201 has a supporting main memory 210 which is used during processing of the query qTree 150. Processing the query qTree 150 is performed by the plurality of threads executed on one or more slave processors 202 (logical and/or physical) which may be utilized through a plurality of platforms employing a plurality of hardware architectures, for example SIMD units 203. Each SIMD unit 203 may include a plurality of multiprocessors 204 each containing a plurality of processors 205. Each processor 205 is capable of independently processing data. The SIMD 203 may include a memory array 211 serving the plurality of processors 205. The SIMD unit 203 may employ various architectures and implementations for the memory 211, for example, separate memory per processor 205, separate memory per multiprocessor 204, global memory serving processors 205 of a single multiprocessor 204, global memory serving multiprocessors 204, global memory serving the SIMD unit 203 and/or any combination of the aforementioned architectures.

During the processing of the query qTree 150, high volumes of data may be transferred between the control processor 201 and the plurality of slave processors 202. To accommodate transfer of the high volumes of data, high bandwidth, high-speed interconnecting devices, fabrics and/or networks 220 may be used, for example, PCI Express, HyperTransport, InfiniBand and/or Ethernet.

More optionally, the plurality of salve processors 202 includes one or more general purpose processors sub-systems 230 which may be utilized through single-core processors and/or multi-core processors 231. The general purpose processor sub-systems 230 may be local to the control processor 201 and share hardware resources with the control unit 201, for example, the memory 210. The general purpose processor sub-systems 230 may be independent having local hardware resources, for example, a local memory 232. The general purpose processor sub-systems 230 may communicate with the control processor 201 through one or more of the plurality of interconnecting devices, fabrics and/or networks 220.

More optionally, the plurality of salve processors 202 includes one or more remote clusters 240. Each remote cluster 240 may include a remote general purpose processor 241 which coordinates the processing sequence on the remote cluster. The remote cluster 240 may communicate with the control processor 201 through one or more of the plurality of interconnecting devices, fabrics and/or networks 220. The remote cluster 240 may include one or more general purpose processors sub-systems 230 and/or one or more SIMD units 203. Within the remote cluster 240, the remote general purpose processor 241 may communicate with the general purpose processors sub-systems 230 and/or one or more SIMD units through one or more of the plurality of interconnecting devices, fabrics and/or networks 220.

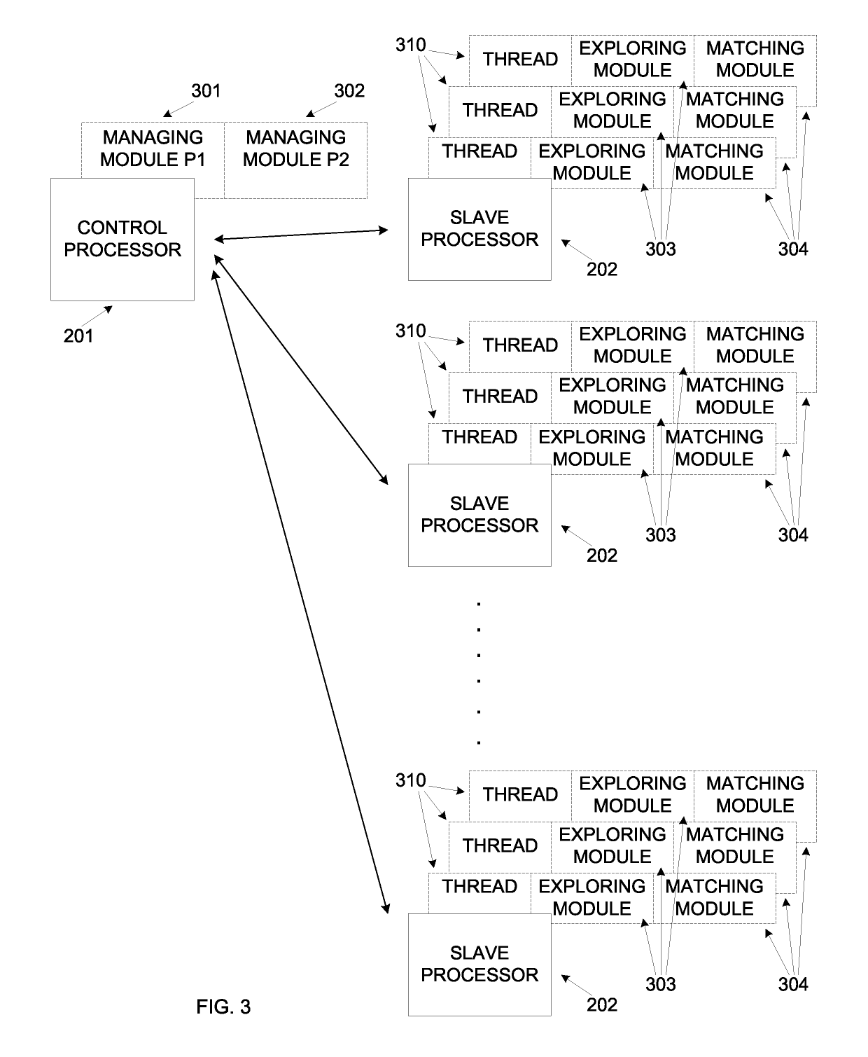

Reference is now made to FIG. 3 which is a schematic illustration of an exemplary system for processing a query to a graph database and optional execution modules that process the query, according to some embodiments of the present invention. Processing the query qTree 150 against the hierarchical structure dTree 100 is performed in two main phases during each phase specific execution modules are executed by the control processor 201 and the plurality of slave processors 202.

The goal of the first phase is to explore the hierarchical structure dTree 100 in bottom up manner to create the plurality of mapping data structures. Each mapping data structure is associated with one of the plurality of nodes within the hierarchical structure dTree 100 that have a common node type and data value as a corresponding node of the query qTree 150. The first phase is controlled by a managing module P1 301 that is executed on the control processor 201. The managing module 301 receives the hierarchical structure dTree 100 and/or parts of the hierarchical structure dTree 100 that are relevant to the query qTree 150 and the query qTree 150 and initiates a plurality of threads 310 that are executed on the plurality of slave processors 202. During the first phase the plurality of threads 310 are operating simultaneously, each executing an exploring module 303. The nodes of the query tree are considered in an order such that a node is considered only after all its query tree descendants have been handled. Each thread 310 executing the exploring module 303 is processing the next node within the hierarchical structure dTree 100 that has the same node type and data value as a corresponding currently considered node in the query qTree 150 and has all child nodes with that same node type in the data graph already processed. The thread 310 explores the hierarchical relationships of the processed node with ancestor nodes within the hierarchical structure dTree 100 with respect to the structure of the query qTree 150. The exploring module 303 then updates the mapping data structure for the ancestor nodes of the processed node to reflect the hierarchical relationship of the processed node in the hierarchical structure dTree 100 with respect to the specification of the query qTree 150. Once all graph nodes corresponding to a considered query node are processed, a next query node is considered in the same manner. This continues until all query nodes are considered. An exemplary pseudo code portraying this process is depicted in later on.

More optionally, the exploration process is performed by the plurality of threads 310 in a plurality of explore iterations in the event that the number of nodes to be processed exceeds the number of available threads 310.

The goal of the second phase is to identify a match of image nodes within the hierarchical structure dTree 100 with respect to target nodes of the query qTree 150 by analyzing the mapping data structures that were created and updated during the first phase. The second phase is controlled by a managing module P2 302 that is executed on the control processor 201. The managing module P2 302 coordinates the process and initiates the plurality of threads 310 that are executed on the plurality of slave processors 202. During the second phase the plurality of threads 310 are operating simultaneously, each executing a matching module 304. Each thread 310 executing the matching module 304 is assigned with a specific data graph node to identify a complete match of the query qTree 150 in which said the specific data graph node is a match to the target node. An exemplary pseudo code portraying this process is depicted later on. In case there are zero target nodes, an arbitrary query node is designated as target and once the process succeeds for any graph node of that group, true is returned. If there is more than one designated target node, a group of nodes, each a possible match for a different target node in the query, are concurrently processed.

More optionally, the analysis process is performed by the plurality of threads 310 in a plurality of analysis iterations in the event that the number of nodes to be processed exceeds the number of available threads 310.

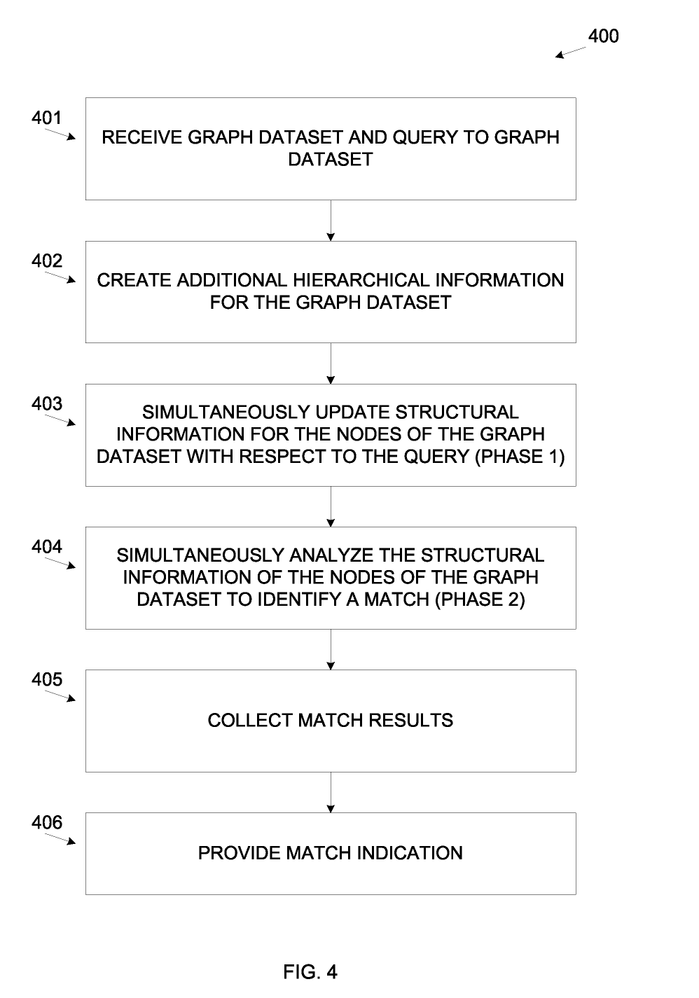

Reference is now made to FIG. 4 which is a schematic illustration of an exemplary process for processing a query to a graph database, according to some embodiments of the present invention. As shown at 401, a process 400 starts with receiving a hierarchical structure such as the hierarchical structure dTree 100 and a query such as the query qTree 150.

As shown at 402, additional hierarchical information is created for the plurality of nodes of the hierarchical structure dTree 100. This information includes enumeration of the nodes and construction of a plurality of node type arrays. This step is performed once, after receiving the hierarchical structure dTree 100 and the information may be used while processing additional queries. This step needs to be performed again, preferably incrementally, when the hierarchical structure dTree 100 is altered, i.e., the structure of the hierarchical structure dTree 100 is changed.

As shown at 403, the hierarchical layout of the plurality of nodes of the hierarchical structure dTree 100 is explored with respect to the query qTree 150 and the mapping data structures are updated. Exploring the hierarchical layout of the nodes is done simultaneously by the plurality of threads 310 as the exploration process for the plurality of nodes is independent from each other. Exploration is performed only for nodes in the hierarchical structure dTree 100 which match a respective currently considered node of the query qTree 150, i.e. the node is of the same node type and holds the same data value. When processing a specific graph node, the mapping data structures of all the ancestor graph nodes of the specific node that comply with the structure of the query qTree 150 are updated to reflect the fact that the specific graph node is a descendant to them.

As shown at 404, the mapping data structures are analyzed to identify nodes within the hierarchical structure dTree 100 which are images of the one or more target nodes of the query qTree 150.

As shown at 405, results are collected from the plurality of threads 310 and aggregated by the control processor 201 to identify all image nodes within the hierarchical structure dTree 150 that match one or more target nodes of the query qTree 150.

As shown at 406, a match indication is provided by the control processor 201. The match indication may be, for example, providing a binary match/no-match indication and/or providing the image nodes within the hierarchical structure dTree 100 that match the one or more target nodes of the query qTree 150.

As aforementioned, the method for processing the query qTree 150 is based on exploring the hierarchical structure hierarchical structure dTree 100 and creating mapping data structures for the plurality of nodes within the hierarchical structure dTree 100 with respect to the query. Only nodes that match a corresponding node of the query (having the same node type and value) are processed and associated with a mapping data structure. The mapping data structures are then analyzed to identify a match of nodes within the hierarchical structure dTree 100 to one or more target nodes of the query qTree 150.

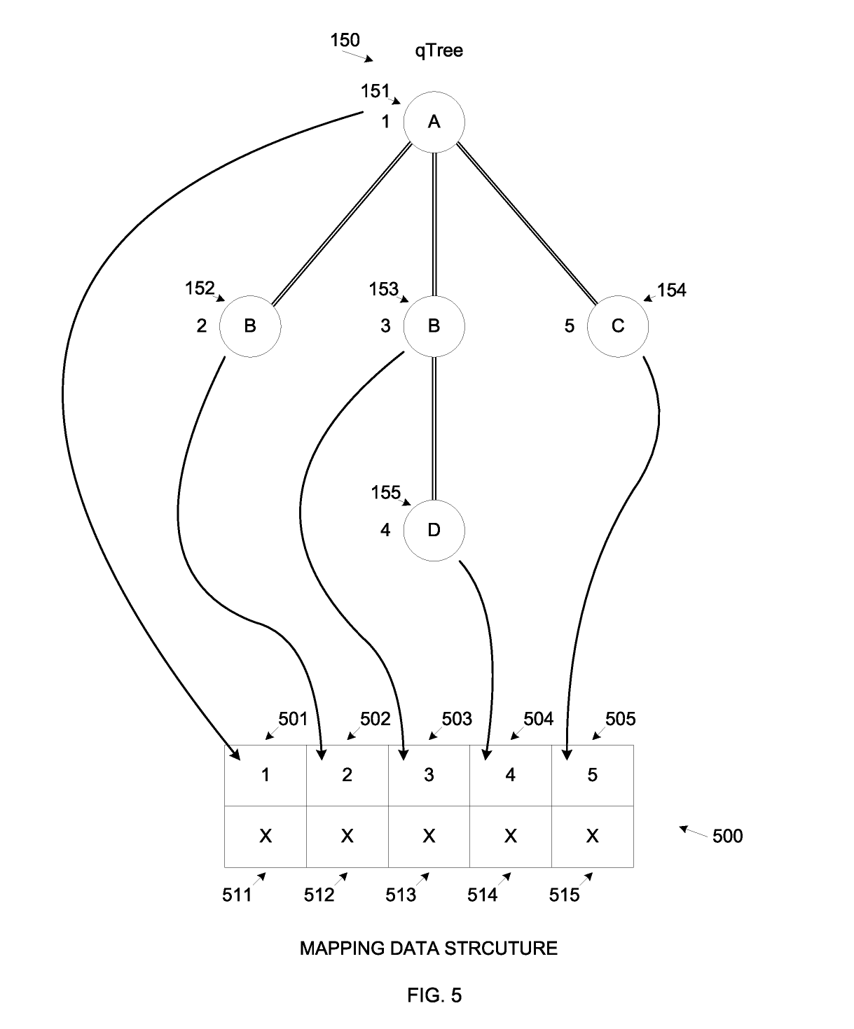

Reference is now made to FIG. 5 which is a schematic illustration of an exemplary mapping data structure corresponding to an exemplary query, according to some embodiments of the present invention. A mapping data structure 500 includes a single binary bit for representing each node of the query qTree 150. Advancing in DFS order, each node of the query qTree 150 is associated with a bit position starting from left to right. A bit 501 is associated with the node 151, a bit 502 is associated with the node 152, a bit 503 is associated with the node 153, a bit 503 is associated with the node 153, a bit 504 is associated with the node 154 and a bit 505 is associated with the node 155. During the first phase of processing the query qTree 150 against the hierarchical structure dTree 100. The contents of the bits 501 through 505, i.e. 511, 512, 513, 514 and 515 is updated according to their hierarchical layout with respect to their descendant nodes.

Some embodiments of the present invention, are presented herein by means of an example, however the use of this example does not limit the scope of the present invention in any way. The example presents an implementation of processing the query 150 against the hierarchical structure dTree 100. The implementation is done using a GPU slave processor 202 that integrates the plurality of processors 205, executing the plurality of threads 310. The GPU is capable of executing CUDA instructions, where CUDA is a proprietary software environment by NVIDIA for designing and executing applications on a GPU multi-processing, multi-threading platform.

A node in the hierarchical structure dTree 100 is qualifying with respect to a corresponding node in the query qTree 150 when:
A leaf node n in the hierarchical structure dTree 100 (a node having no child nodes) qualifies with respect to a corresponding node q in the query qTree 150 if the two nodes n and q have the same label namely qLabel (node type and data value).
A node n in the hierarchical structure dTree 100 which is not a leaf node qualifies with respect to a node q of the query qTree 150 if two criteria are filled. The first criterion is that the two nodes n and q have the same label namely qLabel. The second criterion is that there is a match between all qChild nodes of the node q in the query qTree 150 and a subset of the descendant nodes of the node n in the hierarchical structure dTree 100 such that each descendant node in the subset qualifies with respect to the corresponding qChild nodes qC of the node q in the query qTree 150. The term qChild describes a descendant node to an ancestor node referred to as qParent, where qParent is the node which is closer to the root node of the hierarchical structure. Where the nodes qChild and qParent poses descendant-ancestor relationship which includes as a private case child-parent relationship. The order between the qChild nodes of q does not have to be preserved by their bijection images.

hierarchical structure hierarchical structure Properly setting a bit in the mapping data structure qArray is performed as follows:
A node n with label qLabel is a node in the hierarchical structure dTree 100.
A node q with label qLabel in the query qTree 150 has a qChild node qC with label decLabel and associated with index i.
The bit i is set correctly to true (b1) with respect to the node q when the node n has a descendant node m with label decLabel and the node m is qualifying with respect to qChild and the node m is left qualifying with respect to qC.

Sub-tree correctness is defined as follows:
The mapping data structure qArray of a node n with label qLabel in the hierarchical structure dTree is subtree-correct with respect to a node q in the query qTree 100 if for every qChild nodes of the node q that is associated with an index i, the bit i of the qArray of the node n is set correctly and its value is true (b1).

During the first phase of processing the query qTree against the hierarchical structure dTree, the plurality of threads 310 work in bottom up manner and process the first node in hierarchical structure query tree that has all its child nodes already processed. This means the leaf nodes will be the first to be processed and processing will proceed moving up towards the root of the hierarchical structure dTree 100. Using the additional structural information created prior to processing the query qTree 150, each thread 310 process 310 processes its assigned node and updates the mapping data structures 500 of the nodes in the hierarchical structure dTree 100 that are ancestors of the node that is processed (according to the query tree). This process is repeated until all mapping structures for all relevant nodes (qualifying with respect to the corresponding node in the query qTree 150) in the hierarchical structure dTree 100 are updated. The first phase of the query processing is performed through the Pseudo Code Excerpt 1 below.

Pseudo Code Excerpt 1

| | | |
|---|---|---|
| Input: | 1) | Data tree dTree. |
| | 2) | Twig pattern qTree. |

| Goal: | Create and update the additional structural information for all | |
|---|---|---|
| | nodes in the streams that correspond to qTree nodes. | |
| Method: | (runs on control processor 201). | |
| | 1. | WHILE there are unprocessed nodes in qTree: |

| | |
|---|---|
| 2. | Choose node q from qTree such that all its qChild |
| | nodes are already processed. |
| 3. | SET qStream to q's stream, qIdx to q's index, |
| | pqStream to q's qParent's label stream. |

| | |
|---|---|
| 4. | Invoke the CUDA kernel call for function: |

gpuTwigFirstPhase(qStream, pqStream, qIdx)

| | |
|---|---|
| 5. | Mark q as processed. |

| | |
|---|---|
| 6. | End WHILE. |

gpuTwigFirstPhase kernel function (runs on GPU slave processor 202)

| | | |
|---|---|---|
| Input: | 1) | qStream: q's label stream. |
| | 2) | pqStream: q's qParent's label stream. |
| | 3) | qIdx the index of q in qTree. |

Goal: For each node n in the pqStream, bit qIdx, in the qArray of node n
is set correctly with respect to q's qParent. In particular, if the node n has
a descendant which is qualifying with respect to q, bit qIdx is set to true.

| | | |
|---|---|---|
| Method: | 1. | Set idx to a system assigned index of the current thread. |
| | 2. | IF idx ≧ number of nodes in qStream then RETURN. |
| | 3. | Set n to node at index idx of qStream. |
| | 4. | IF subtreeCorrect(q,n) == true THEN. |

| | |
|---|---|
| 5. | FOREACH node pn in the pqLabel stream that is an |
| | ancestor of n. |
| 6. | atomicAssign(pn.qArray[qIdx],true). |
| 7. | END FOREACH. |

// subtreeCorrect function:

| | | |
|---|---|---|
| Input: | 1) | q: node in qTree. |
| | 2) | n: node in dTree. |
| Output: | | Boolean value. |
| Method: | 1. | res = true. |
| | 2. | FOREACH qChild node qC of q. |

| | |
|---|---|
| 3. | SET i to the index of qC. |
| 4. | IF n.qArray[i] == false THEN. |

| | |
|---|---|
| 5. | res = false; BREAK. |

| | |
|---|---|
| 6. | END FOREACH. |
| 7. | RETURN res. |

The gpuTwigFirstPhase kernel is executed on the GPU and processes the nodes of the hierarchical structure to correctly set the bit qIdx in a mapping data structure qArray for each of the nodes that are qualifying with respect to a corresponding node of the query. The bit qIdx is set in qArray if the descendant node that is associated with bit qIdx is qualifying with respect to its corresponding node in the query. The first line of the gpuTwigFirstPhase kernel assigns the task to the current available thread 310. The function atominAssign ( ) is used to avoid a race condition between two threads 310. The subtreeCorrect ( ) function checks if the node n is subtree-correct with respect to the node q.

During the first phase of processing the query qTree against the hierarchical structure dTree, the plurality of threads 310 analyze the mapping data structures 500 to identify images of the query nodes in the query qTree 150. Processing is performed in bottom up manner. The path to the root node of the query qTree 150 is analyzed for each potential node in the hierarchical structure dTree 100 that qualifies with respect to a query node in the query qTree 150. The path is analyzed to verify that each node on the path has at least one match with respect to the path from the query node to the root of the query qTree 150. The second phase of the query processing is performed through the pseudo code excerpt described in Code Excerpt 2 below.

Pseudo Code Excerpt 2:

| Input: | 1) | Data tree dTree. |
|---|---|---|
| | 2) | Twig pattern qTree. |
| Output: | ansSet, the set of all answer nodes of qTree in dTree. | |
| Method: | (runs on control processor 201). | |
| | 1. | SET node qAnsN to be the node in qTree whose isAnswer |

field value is true (the target node):

| | |
|---|---|
| 2. | Invoke CUDA kernel call for function: |

gpuTwigSecondPhase (qAnsN, qTree).

| | |
|---|---|
| 3. | Insert to ansSet all the nodes from the qAnsN stream whose |
| | answer isAnswer bit is to bit is true. |

gpuTwigiSecondPhase kernel function (runs on GPU slave processor 202)

| Input: | 1) | qAnsN: node qAnsN from qTree. |
|---|---|---|
| Goal: | Find the answer nodes in the stream of qAnsN. | |
| Method: | 1. | Set idx to a system assigned index of the current thread. |
| | 2. | set qStream to be the stream of (the label of) qAnsN. |
| | 3. | IF idx ≧ number of nodes in qStream then RETURN. |
| | 4. | Set n to node at index idx of qStream. |
| | 5. | SET currQN to qAnsN and CurrSN to n. |
| | 6. | IF subtreeCorrect (CurrQN, currSN) == false then |
| | | TEHN RETURN. |
| | 7. | set rq to be the root node in qTree. |
| | 8. | WHILE the index of currQN > the index of rq. |

| 9. | SET pCurrQN to the qParent parent node of currQN. |
|---|---|
| 10. | SET pCurrQL to the label of pCurrQN. |
| 11. | IF currSN has no ancestor with label pCurrQL THEN |
| | BREAK. |
| 12. | SET upperL (respectively, lower L) to the node with |
| the smallest (respectively, largest) leftPos value which is an | |
| ancestor of currSN and is in the pCurrQL stream. | |
| 13. | SET ancN to NULL. |
| 14. | FOREACH node n between lowerL and upperL in the |

pCurrQL stream.

/* note that lower to upper is crucial */

| | |
|---|---|
| 15. | IF subtreeCorrect (currQN, currSN) == true |
| | THEN. |

| | |
|---|---|
| 16. | SET ancN to n; BREAK. |

| | |
|---|---|
| 17. | END FOREACH. |
| 18. | IF ancN == NULL THEN BREAK. |
| 19. | SET currSN to ancN and currQN to pCurrQN. |

| | |
|---|---|
| 20. | END WHILE. |
| 21. | IF currQN == rq and ancN is not NULL THEN. |

| | |
|---|---|
| 22. | set n.isAnswer to true. |

The gpuTwigSecondPhase kernel is executed on the GPU and processes each node in the hierarchical structure dTree 100 that is a potential match to a target node in the query qTree 150. Starting from the bottom, the ancestors of each potential answer node are checked if they are subtree-correct with respect to twig of the query qTree 100. The first line of the gpuTwigSecondPhase kernel assigns the task to the current available thread 310.

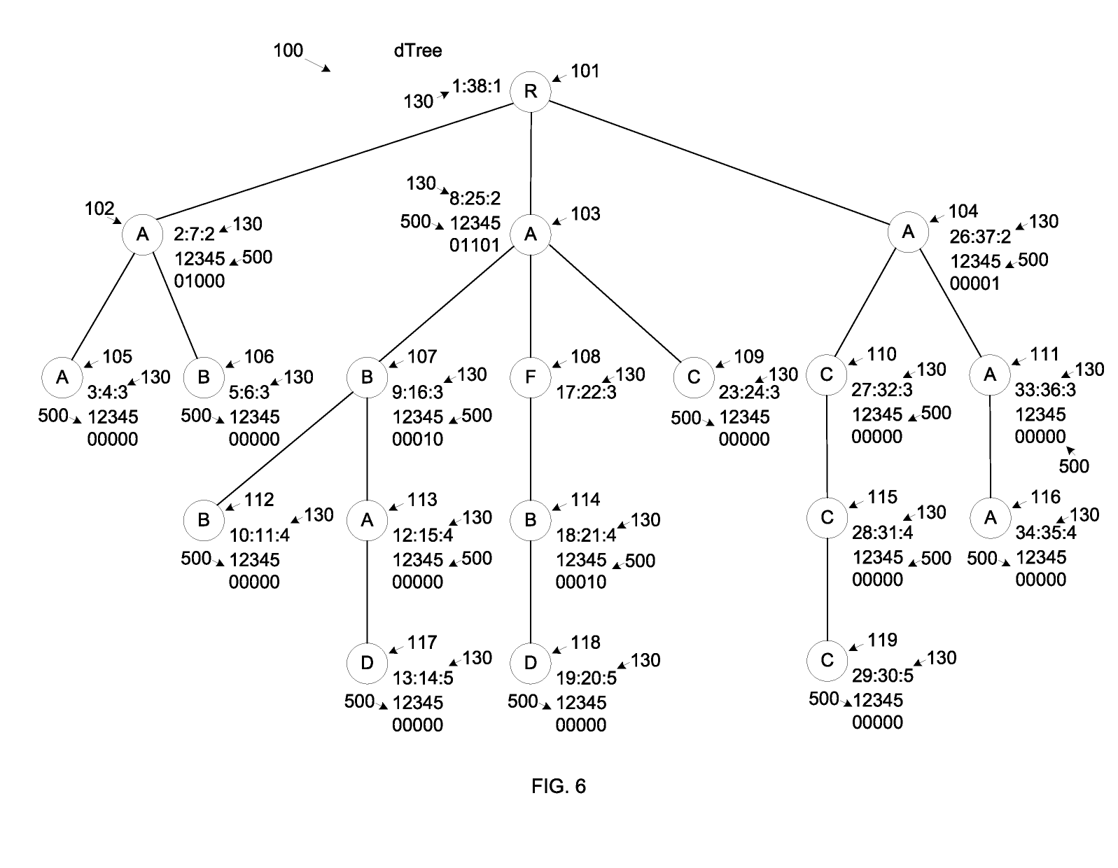

Reference is now made to FIG. 6 which is a schematic illustration of an exemplary hierarchical structure with updated mapping data structures, according to some embodiments of the present invention. The query qTree 150 is processed against the hierarchical structure dTree 100 using the exemplary CUDA code as presented above. During the first phase of processing the query qTree 150 against the hierarchical structure dTree 100, each node of the hierarchical structure dTree 100 is processed to update the mapping data structures 500 of its ancestor nodes. Since only nodes which match a respective node within the query qTree 150 are processed, the node 108 which does not match any of the nodes within the query qTree 150, is not processed and a mapping data structure 500 is not created for the node 108. For node 103 for example, the bit 603 of the mapping data structure 500 of the node 103 is true (b1) because the mapping data structure 500 of the node 114 is subtree-correct with respect to node 153 and because the node 114 is left qualifying with respect to the node 153 and the node 103. During the second phase for the node 109 for example, the parent node of the corresponding target node 154 (with label C) is the node 151 with label A. The only ancestor the node 109 has that is with label A is the node 103. The node 103 is subtree-correct with respect to the node 151. Therefore, the node 109 is included in the answer set and is an answer for the target node 154.

According to some embodiments of the present invention, there are provided systems and methods for creating additional hierarchical structural information to support the systems and methods described herein for processing a query to a hierarchical structure. A plurality of hierarchical data structures are constructed in order to allow for efficient navigation and data retrieval by the plurality of threads 310 during processing a query to a hierarchical structure. The additional data structures may be referred to as streams. The information which is included for each node in each constructed data structure includes link information which points to other data structures which contain a node which is on the path to the root node of the hierarchical structure.

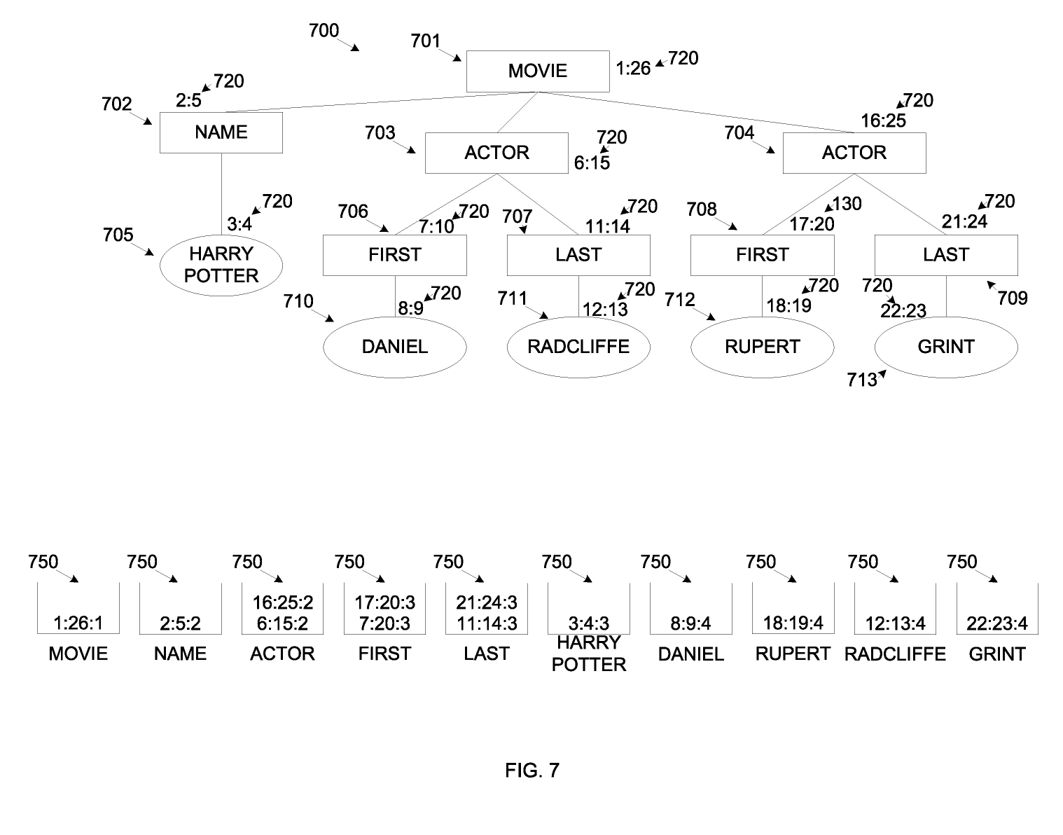

Reference is now made to FIG. 7 which is a schematic illustration of exemplary hierarchical data structures for an exemplary hierarchical structure, according to some embodiments of the present invention. A hierarchical structure 700 includes a plurality of nodes 701 through 713. The nodes are enumerated in DFS order with and an enumeration tag 720 is assigned to each of the nodes. The enumeration tag 720 includes the opening index and the closing index for each of the nodes. Node data structures 750 are constructed to allow the threads 310 simple navigation and understanding of the hierarchical structure of the hierarchical structure 700. The node data structures 750 (also referred to as streams) are arranged by labels, where each node of a specific label has an entry in the corresponding node data structures 750. In addition, link information is also included in the node data structures 750. The link information identifies the links between each node within the node data structure 750 and all its ancestor nodes that are on the path to a root node 701 of the hierarchical structure 700. Each node entry in the node data structure 750 holds link information that points to other node data structures 750 which include ancestor nodes. The link information includes the name of the node data structure that stores the ancestor node and an index in the pointed node data structure that identifies the entry of the ancestor node.

For example, the entry 8:9:4 which is associated with the node 710 is included in the node data structure 750 that is associated with the label DANIEL. The entry of node 8:9:4 will include the following link information:
The node 706 is an ancestor of the node 710. Therefore, a link is created for the entry 8:9:4 to the entry 7:10:3 which is associated with the node 706 in the node data structure associated with the label FIRST.
The node 703 is an ancestor of the node 710. Therefore, a link is created for the entry 8:9:4 to the entry 6:15:2 which is associated with the node 703 in the node data structure associated with the label ACTOR.

Optionally, a plurality of leaf nodes is included in a single node data structure. Since by definition each leaf node has a different node type (label), each leaf node needs to be associated with another node data structure 750. This may require large memory capacity to store all the node data structures 750. In order to reduce memory usage all or part of the leaf nodes are included in a single node data array 750. The leaf nodes are sorted within the node data array 750 in ascending order according to their node type (label). As they are sorted, the information for the leaf nodes may be easily accessed and retrieved.

What is claimed is:

1. A method of processing a hierarchical structure to respond to a query, comprising:
providing a hierarchical structure having a plurality of nodes of a plurality of node types;
receiving a query that defines a hierarchical query pattern defining hierarchical relationship between at least two query nodes;
simultaneously exploring said hierarchical structure in a bottom up manner by a plurality of threads to update a mapping data structure for each hierarchical structure node of said plurality of nodes that has the same node type as a corresponding query node of said at least two query nodes; and
simultaneously analyzing said mapping data structure by said plurality of threads to identify at least one portion of said hierarchical structure that matches said hierarchical query pattern;
wherein each said thread updates said mapping data structure for each ancestor node of said each hierarchical structure node according to a match between said each ancestor node and a corresponding parent node of said corresponding query node.

2. The method of claim 1, wherein said plurality of threads are executed simultaneously by a plurality of slave processors.

3. The method of claim 1, wherein said exploring is performed in a plurality of iterations, during each said iteration another subset of said plurality of nodes is explored to update said mapping data structure with respect to another one of said at least two query nodes.

4. The method of claim 1, wherein said analyzing is performed in a plurality of iterations, during each said iteration said mapping data structure is analyzed for a subset of said plurality of nodes with respect to another said query node.

5. The method of claim 1, wherein said plurality of nodes are enumerated prior to said exploration in order to provide positioning information for the plurality of nodes, said positioning information is used by said plurality of threads to navigate through said hierarchical structure.

6. The method of claim 5, wherein said enumeration employs depth first search (DFS) order starting at a root node of said hierarchical structure, during said enumeration said plurality of nodes is assigned with a tree level indication, an opening index and a closing index to identify the exact hierarchical position of each of said plurality of nodes within said hierarchical structure.

7. The method of claim 1, wherein said ancestor include parent nodes.

8. The method of claim 1, further comprising collecting results of said analyzing and outputting a match indication.

9. The method of claim 8, wherein said match indication includes a reference to at least one portion of said hierarchical structure that matches said hierarchical pattern, said portion includes at least one node.

10. The method of claim 1, wherein said hierarchical structure is an extensible markup language (XML) dataset.

11. A system of processing a hierarchical structure to respond to a query using a plurality of slave processors, comprising:
a storage which hosts a hierarchical structure having a plurality of nodes;
a plurality of slave processors executing a plurality of threads; and
a control processor which processes said hierarchical structure to respond to a query by instructing said plurality of threads to explore simultaneously said hierarchical structure and to update a mapping data structure to indicate which of said plurality of nodes has a node type and a set of ancestor nodes that are common with a respective node of said query and analyzing said updated mapping data structure to identify at least one portion of said hierarchical structure that matches with respect to at least one corresponding node of said query;
wherein each of said plurality of threads is exploring and analyzing one of said plurality of nodes at a time.

12. The system of claim 11, wherein said plurality of slave processors is embedded within at least one single instruction multiple data (SIMD) hardware unit.

13. The system of claim 12, wherein said SIMD hardware unit is a graphic processing unit (GPU).

14. The system of claim 11, wherein said plurality of slave processors and said control processor are integrated within the same hardware platform, said platform is sufficient for processing said hierarchical structure.

15. The system of claim 11, wherein said plurality of slave processors includes one or more general purpose processors having at least one processing core.

16. The system of claim 11, wherein said plurality of slave processors includes at least one remote clusters that includes at least one slave processor, said at least one remote clusters communicates with said control processor to synchronize processing said hierarchical structure.

17. A method of creating additional structural hierarchical information of a hierarchical structure with respect to a query, comprising:
constructing a plurality of node type arrays, each said node type array includes a plurality of node entries, each node entry is associated with a one of a plurality of nodes within a hierarchical structure having a common node type; and
updating said node entries with node link information, said link information describes links of each of said plurality of nodes to ancestor nodes.

18. The method of claim 17, wherein said ancestor nodes include parent nodes.

19. The method of claim 17, wherein a single said node type array is assigned to a plurality of leaf nodes in order to reduce memory consumption, said plurality of leaf nodes are sorted within said single node type array in ascending order according to said node type.

20. The method of claim 17, wherein said hierarchical structure is an extensible markup language (XML) dataset.
